(19) United States
(12) Patent Application Publication
(10) Pub. No.: US 2009/0182775 A1
(43) Pub. Date: Jul. 16, 2009

(54) Imaging apparatus, picture managing method, and program

(75) Inventor: Kazumi Yoshimoto, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/319,845

(22) Filed: Jan. 13, 2009

(30) Foreign Application Priority Data
Jan. 15, 2008 (JP) P2008-005670

(51) Int. Cl. G06F 17/30

(52) U.S. Cl. 707/104.1; 707/E17.019

(57) ABSTRACT

The present invention provides an imaging apparatus includes: a first storage section configured to store picture files; a second storage section configured to store a database for storing registration information and picture files, the second storage section being removably attached to the imaging apparatus; and a control section configured to create the registration information about the picture files to be copied from the first storage section to the second storage section at a suitable time, the control section further adding the created registration information to the database so as to maintain consistency between the picture files and the registration information.

### CROSS REFERENCES TO RELATED APPLICATIONS

The present invention contains subject matter related to Japanese Patent Application JP 2008-005670 filed with the Japan Patent Office on Jan. 15, 2008, the entire contents of which being incorporated herein by reference.

### BACKGROUND OF THE INVENTION

1. Field of the Invention

The present invention relates to an imaging apparatus such as a digital camera or the like, a picture managing method, and a program for recording picture data to removable recording medium.

2. Description of the Related Art

Ordinarily, imaging apparatus such as digital cameras or the like is capable of recoding picture data to recording media such as Memory Stick (registered trademark) and the like which are removably attached to the apparatus body. Based on the picture data written to such a removable recording medium, the apparatus proper may display pictures using a display unit such as an LCD (liquid crystal display) or the like for viewing purposes. If the recording medium removed from the imaging apparatus is attached to an external apparatus such as a personal computer or the like, the picture data may be read from the medium by that external apparatus and stored inside and/or displayed for viewing.

Today, the internal memory for imaging apparatus is getting larger in capacity all the time and may accommodate almost as much picture data as removable recording medium. When it is desired to move picture data stored in the internal memory to an external apparatus for storage or for viewing purposes, it is customary to copy the picture data from the internal memory to recording media for use by the external apparatus.

Illustratively, Japanese Patent Laid-open No. 2007-174556 (hereinafter referred to as Patent Document 1) discloses a digital camera which checks picture data files in its internal memory against those in a memory card for data consistency. If a picture data file not stored in the memory card is found in the internal memory, the picture data file in question is copied from the internal memory of the camera to the memory card (described specifically in Paragraph [0039] of the Patent Document 1).

### SUMMARY OF THE INVENTION

The above Patent Document 1 neither discloses nor suggests techniques for managing registration information using a database in the memory card. Since removable recording medium generally do not have any database, when picture files written to the internal memory with the memory card removed are to be copied to the removable recording medium having no database, no registration information about the picture files to be copied can be written to the putative database. There is then no way of carrying out functions that would utilize a database arrangement (e.g., selective display of pictures based on favorite information).

The present invention has been made in view of the above circumstances and provides arrangements which, when picture files are to be copied from an internal memory to a removable recording medium, create registration information anew about the picture files to be copied and write the created registration information to a database on the recording medium, whereby consistency between the registration information and the picture files is maintained and functions utilizing the database may be implemented.

In carrying out the present invention and according to one embodiment thereof, there is provided an imaging apparatus including: a first storage section configured to store picture files; a second storage section configured to store a database for storing registration information and picture files, the second storage section being removably attached to the imaging apparatus; and a control section configured to create the registration information about the picture files to be copied from the first storage section to the second storage section at a suitable time, the control section further adding the created registration information to the database so as to maintain consistency between the picture files and the registration information.

According to the inventive imaging apparatus embodied as outlined above, when picture files are to be copied from the first storage section such as an internal memory to the second storage section such as a recording medium having a database, registration information about the picture files is created anew and added to the database so that consistency is maintained between the registration information and the picture files.

With the above embodiment in use, the control section may preferably number file paths for the picture files to be copied and acquire supplementary information about the picture files before adding the file paths and the supplementary information to the database as part of the registration information. In another preferred structure of the embodiment, the suitable time may correspond to the point in time at which the second storage section is detected to be attached to the imaging apparatus after reproduction of picture files has been started. In a further preferred structure of the embodiment, the suitable time may correspond to the point in time at which reproduction of picture files is started after the second storage section has been detected to be attached to the imaging apparatus.

According to another embodiment of the present invention, there is provided a picture managing method including the steps of: creating registration information about picture files to be copied from a first storage section to a second storage section at a suitable time; and adding the registration information to a database constituting part of the second storage section so as to maintain consistency between the picture files and the registration information.

Where the inventive picture managing method embodied as outlined above is in use, registration information is created anew about the picture files to be copied from the first storage section such as an internal memory to the second storage section such as a recording medium having a database, the registration information being added to the database so that consistency is maintained between the registration information and the picture files.

According to a further embodiment of the present invention, there is provided a program for causing a computer to perform a control procedure including the steps of: creating registration information about picture files to be copied from a first storage section to a second storage section at a suitable time; and adding the registration information to a database constituting part of the second storage section so as to maintain consistency between the picture files and the registration information.

Where the inventive program embodied as outlined above is in use, registration information is created anew by software about the picture files to be copied from the first storage section such as an internal memory to the second storage section such as a recording medium having a database, the registration information being added to the database so that consistency is maintained between the registration information and the picture files.

As outlined above, the present invention envisages providing an imaging apparatus, a picture managing method, and a program for newly creating registration information about picture files to be copied from an internal memory to a removable recording medium having a database, the created registration information being written to the database so as to maintain consistency between the registration information and the picture files.

### BRIEF DESCRIPTION OF THE DRAWINGS

FIG. 1 is a schematic view showing a typical structure of an imaging apparatus practiced as one embodiment of the present invention;

FIG. 2 is a conceptual view showing a typical flow of processes for copying picture files;

FIG. 3 is a conceptual view showing other processes characteristic of the imaging apparatus embodying the present invention;

FIG. 4 is a flowchart of steps constituting a typical procedure characteristic of the embodiment of the invention; and

FIG. 5 is a schematic view showing a typical structure of an imaging apparatus practiced as another embodiment of the present invention.

### DETAILED DESCRIPTION OF THE PREFERRED EMBODIMENTS

The preferred embodiments of the present invention will now be described in detail with reference to the accompanying drawings.

An imaging apparatus embodying the present invention stores picture files into its internal memory when a removable recording medium is not attached to the apparatus or when the capacity of the attached recording medium is not sufficient to accommodate the files. When copying the picture files subsequently from the internal memory to an attached removable medium, the imaging apparatus creates registration information anew about the picture files to be copied and writes the created registration information to a database of the recording medium. These inventive arrangements maintain consistency between the registration information and the picture files and permit implementation of functions that utilize the database. The imaging apparatus embodied as outlined above will now be described below in detail.

### First Embodiment

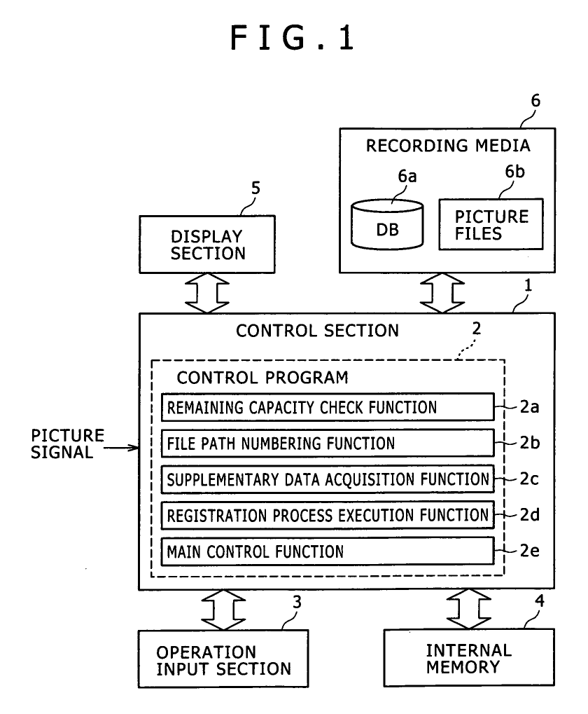

FIG. 1 schematically shows a typical structure of the imaging apparatus practiced as a first embodiment of the present invention.

As shown in FIG. 1, the imaging apparatus includes a control section 1 and an operation input section 3 which make up a control section for overall control of the apparatus, an internal memory 4 serving as a first storage section, a display section 5, and recording media 6 serving as a second storage section.

The control section 1 executes a control program 2 retrieved from the internal memory 4 in order to implement at least a remaining capacity check function 2a, a file path numbering function 2b, a supplementary data acquisition function 2c, a registration process execution function 2d, and a main control function 2e. Each piece of recording media 6 has a database 6a for storing registration information (e.g., file path information and date information or the like) and picture files 6b for accommodating picture data.

With the above-described structure in use, the remaining capacity check function 2a checks the remaining capacity of each recording medium 6. The file path numbering function 2b numbers a new file path for each picture file 6b to be copied to the recording medium 6. The supplementary data acquisition information 2c acquires supplementary information such as date and face information or the like from the picture files 6b. When a new picture file 6b is added to the recording medium 6, the registration process execution function 2b writes new registration information about the picture file 6b in question to the database 6a. The main control function 2e carries out other processes.

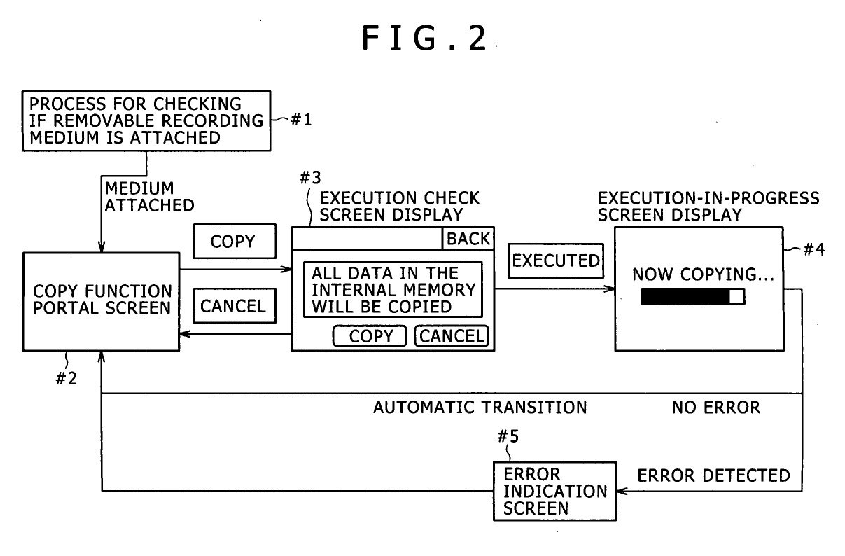

The processes characteristic of the inventive imaging apparatus will be outlined below by referring to the conceptual view of FIG. 2.

Using the main control function 2e, the control section 1 checks to determine whether or not the recording medium 6 is attached to the apparatus (process #1). If the recording medium 6 is found to be attached, the control section 1 causes the display section 5 to display a portal screen through which to start the copy function (process #2). If the copy function is selected on the copy function portal screen, the control section 1 causes the display section 5 to display an execution check screen (process #3). When execution (“COPY”) is selected, the control section 1 causes the display section 5 to display an execution-in-progress section (process #4). If no error is detected, the control section 1 effects automatic transition to the copy function portal screen. If an error is detected, then the control section 1 causes the display section 5 to display an error indication screen (process #5), before making transition to the copy function portal screen.

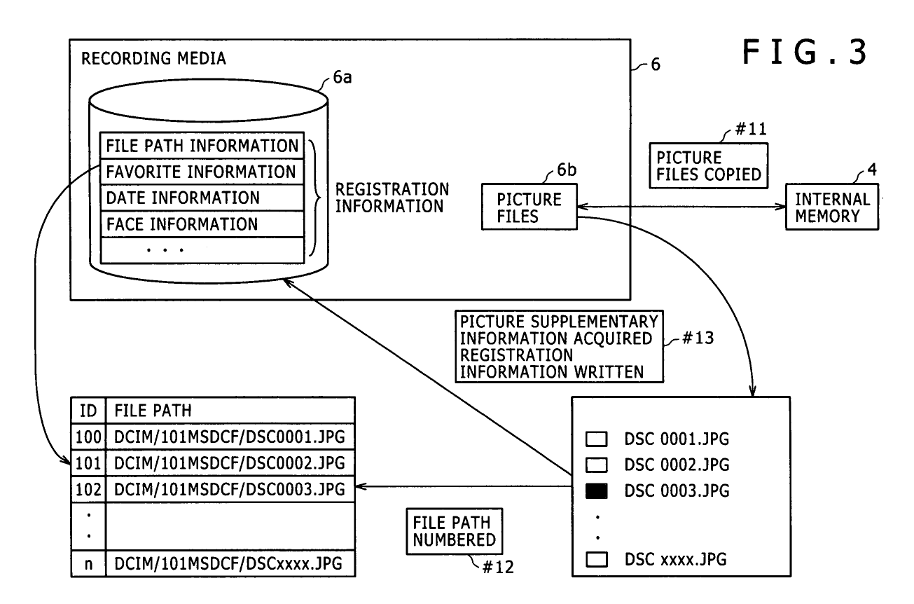

Described below in detail with reference to the conceptual view of FIG. 3 are typical processes involved in copying picture files from the internal memory 4 to the recording media 6.

As shown in FIG. 3, the database 6a of the recording medium 6 accommodates such information as file path information, favorite information, date information, and face information as registration information. The file path information is defined in such a manner as to associate each file name with picture data, as in “DCIM/101MSDCF/DSC001.JPG,” the information further associating each file path with an ID.

For example, if reproduction mode is selected for reproducing a picture, the file path information about the corresponding picture file is first acquired from the database 6a of the recording medium 6. Then the picture file 6b (e.g., a still picture file or its thumbnail) identified by the file path information is reproduced.

Suppose now that, as shown in FIG. 3, the picture files 6b are to be copied from the internal memory 4 to the recording medium 6 (process #11). In that case, the control section 1 carries out the control program 2 to initiate the registration process execution function 2d. This function 2d works as follows:

The database 6a of the recording medium 6 holds such information as file path information, favorite information, date information, and face information as registration information.

The file path information associates the picture files with their corresponding ID's. Typical file paths are given as

100/DCIM/101MSDCF/DSC0001.JPG

101/DCIM/101MSDCF/DSC0002.JPG

102/DCIM/101MSDCF/DSC0003.JPG
. . .
   n/DCIM/101MSDCF/DSCxxxx.JPG
      as indicated in FIG. 3 (ID's are 100, 101, . . . n).

The control section 1 compares the file path information with the picture files 6b using the file path numbering function 2b. If there is no registration information corresponding to a given picture file 6b, then the control section 1 numbers a file path for the picture file in question (process #12). In this example, there is no file path information regarding a newly added picture file DSC0003.JPG. A new file path is thus numbered for the picture file in question.

Furthermore, the control section 1 acquires supplementary data (e.g., date and face information) about the added picture file using the supplementary data acquisition function 2c. The registration process execution function 2d then writes the acquired supplementary data to the database (process #13).

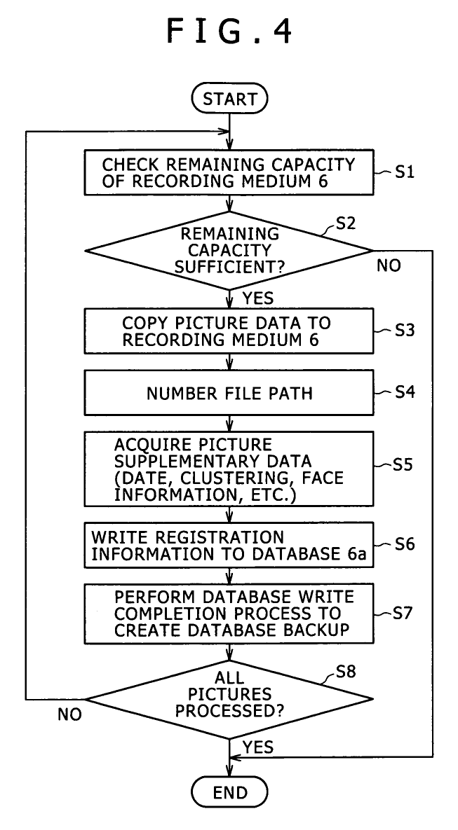

Described below in reference to the flowchart of FIG. 4 is a typical procedure characteristic of the imaging apparatus practiced as the first embodiment of the invention.

Transition to this procedure takes place either when the recording medium 6 is found to be attached following transition to reproduction mode, or when reproduction mode is selected after detection of the recording medium 6 being attached. It should be noted that the time to start the procedure is not limited to the time of the transition taking place.

When the procedure is started, the control section 1 checks the remaining capacity of the removable recording medium 6 using the remaining capacity check function 2a in step S1. Based on the result of the check, the control section 1 determines in step S2 whether the recording medium 6 has a sufficient capacity to have the picture file of interest copied thereto (i.e., to accommodate an increase in file size in the database).

If the remaining capacity of the recording medium 6 is not found to be sufficient (“No” in step S2), then an error is detected and the processing is terminated. If the remaining capacity of the removable recording medium 6 is found sufficient, then the picture file of interest is copied to the recording medium 6 in step S3.

In step S4, a folder is provided or a file path is numbered for the copied picture file illustratively in accordance with the DCF standard. In step S5, supplementary information is acquired about the copied picture file. The supplementary information may typically include Exif data, face information derived from face detection processing based on a face detection algorithm, and date and time information furnished by a clustering engine.

In step S6, the supplementary information thus acquired is written to the database 6a as registration information. In step S7, a predetermined database write completion process is carried out to create a database backup against possible destruction of the database 6a. In step S8, a check is made to determine whether all additional picture files have been processed or not. Steps S1 through S8 are repeated until all picture files have been handled. When all picture files are found to have been dealt with (“Yes” in step S8), the processing is brought to an end.

Where the first embodiment of the present invention is used as discussed above, it might happen that picture files are added to the internal memory 4 while the recording medium 6 is not attached or the like and that the additional picture files are copied subsequently to the attached recording medium 6 illustratively upon transition to reproduction mode. In that case, new file paths are created for the picture files to be copied to the recording medium 6. Supplementary information is then acquired about the picture files in question and written anew as registration information to the database 6a of the recording medium 6. These arrangements ensure consistency between the registration information and the picture files so that functions utilizing the database 6b may be implemented.

### Second Embodiment

A second embodiment of the present invention will now be described.

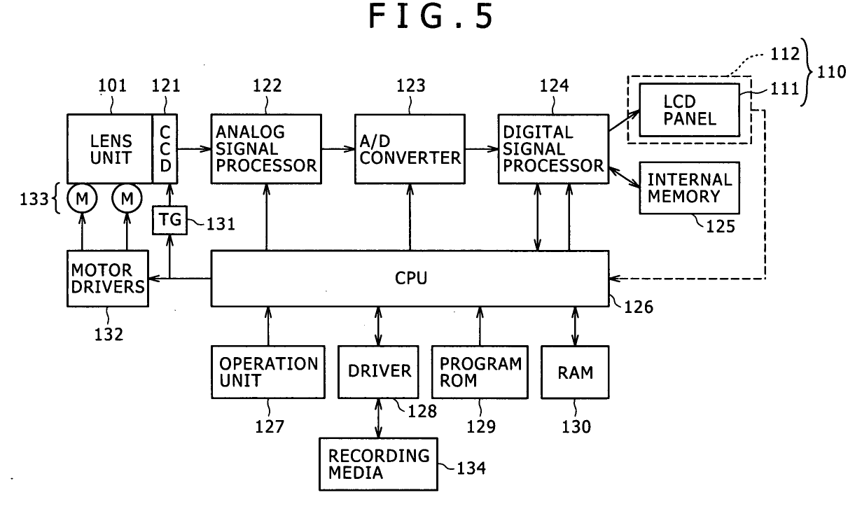

FIG. 5 schematically shows a typical structure of a digital camera practiced as the embodiment of the invention.

The second embodiment involves implementing the invention more specifically in the form of a digital camera.

As shown in FIG. 5, the digital camera has a lens unit 101 that conceptually includes object lens, aperture, and focusing lens elements. The light coming from the object being imaged and entering the lens unit 101 constitutes an optical path on which is positioned an imaging device 121 such as a CCD (charge coupled device). The output of the imaging device 121 is connected to the input of a digital signal processor 124 via an analog signal processor 122 and an analog/digital (A/D) converter 123. The output of the digital signal processor 124 is connected electrically to the input of an LCD panel 111. The lens unit 101 is connected mechanically with an actuator 133 for driving some of the elements in the unit 101, e.g., adjusting the aperture and moving the focusing lens. The actuator 133 is in turn connected with motor drivers 132 for controlling such drive operations.

The digital camera also has a CPU (central processing unit) 126 for overall control. The CPU 126 is connected with the motor drivers 132, a timing generator (TG) 131, an internal memory 125, an operation unit 127, a driver 128, a program ROM (read only memory) 129, a RAM (random access memory) 130, and a touch-sensitive panel 112.

In operation, the CPU 126 reads a control program from the program ROM 129 and executes the retrieved program. In so doing, the CPU 126 functions as the control section and operates in particular as the remaining capacity check function, file path numbering function, supplementary data acquisition function, registration process execution function, and main control function or the like.

The touch-sensitive panel 112 and LCD panel 111 make up a touch-sensitive screen 110. The internal memory 125 is typically a flash memory or some other mass memory. The program ROM 129 stores the programs to be executed by the CPU 126 as well as the data needed during such program execution. The RAM 130 serves as a work area that temporarily accommodates the programs and data executed and operated on by the CPU 126 in carrying out its diverse processing.

In the above-described structure, the CPU 126 performs the programs held in the program ROM 129 to control the components of the imaging apparatus. Given signals from the touch-sensitive panel 112 or from the operation unit 127, the CPU 126 carries out suitable processes accordingly. The user operates the operation unit 127 which in turn supplies the CPU 126 with the signals reflecting the user's operations.

Illustratively, when a given location on the touch-sensitive panel 112 is touched typically by fingertips, i.e., when the user performs a desired input operation, the coordinates of the touched location on the panel 112 are detected and a signal representing the coordinates is sent to the CPU 126. In turn, the CPU 126 acquires predetermined information about the coordinates and carries out an appropriate process based on the acquired information.

When the light from the object being imaged enters the lens unit 101, the imaging device 121 photoelectrically converts the incident light into an analog picture signal that is output. At this point, the motor drivers 132 drive the actuator 133 under control of the CPU 126. The drive operations cause the lens unit 101 to be exposed from or housed into the enclosure of the imaging apparatus. The drive operations further adjust the aperture and move the focusing lens inside the lens unit 101.

The timing generator 131 feeds a timing signal to the imaging device 121 under control of the CPU 126. The timing signal allows exposure time and other settings to be controlled for the imaging device 121. By operating on the timing signal from the timing generator 131, the imaging device 121 subjects the incident light from the object being imaged and coming through the lens unit 101 to photoelectrical conversion. The converting process produces an analog picture signal acting as an electrical signal that reflects the amount of the light being received. The analog picture signal is forwarded to the analog signal processor 122.

Under control of the CPU 126, the analog signal processor 122 performs analog signal processing (such as amplification) on the analog picture signal received from the imaging device 121. The picture signal resulting from the processing is sent to the A/D converter 123.

Given the analog picture signal from the analog signal processor 122, the A/D converter 123 under control of the CPU 126 converts the signal from analog to digital format. The resulting digital picture data is supplied to the digital signal processor 124. Under control of the CPU 126, the digital signal processor 124 carries out digital signal processing such as noise removal on the digital picture signal from the A/D converter 123. The signal thus processed is sent to the LCD panel ill for display.

The digital signal processor 124 compresses the digital picture signal coming from the A/D converter 123 illustratively according to the JPEG (joint photographic experts group) standard. The digital picture signal thus compressed is either fed to the internal memory 125 for storage or written to a recording medium 134 having a database via the driver 128.

The digital signal processor 124 further expands the compressed picture data from the internal memory 125, and sends the expanded picture data to the LCD panel 111 for display. That is, the digital signal processor 124 supplies the LCD panel 111 with the picture data coming from the A/D converter 123 in such a manner that the LCD panel 111 displays what is known as a through-picture.

When the user subsequently pushes a shutter button included conceptually in the operation unit 127, the operation unit 127 sends a release signal to the CPU 126. Upon receipt of the release signal, the CPU 126 controls the digital signal processor 124 to compress the picture data received from the A/D converter 123, and causes the compressed picture data to be written either to the internal memory 125 or to the recording medium 134 via the driver 128.

What characterizes the second embodiment are the following operations: when pictures are taken without the recording medium 134 being attached, corresponding picture data (i.e., picture files) is processed by the digital signal processor 124 in predetermined fashion before being written to the internal memory 125. Since the internal memory 125 does not have a database like the one on the recording medium 134 for storing registration information, solely the picture files are written to the internal memory 125. When the recording medium 134 is subsequently found attached by the CPU 126 and when reproduction mode or the like is selected, the picture files held in the internal memory 125 are copied to the recording medium 134. At this point, file paths are numbered anew for the picture files and date and face information about the picture files is created as registration information. The created registration information is added to the database of the recording medium 134. If the recording medium 134 does not have a database, a new database is created on the medium 134. In this manner, consistency is maintained between the picture files copied from the internal memory 125 on the one hand and the registration information on the other hand.

As described, the first and the second embodiments of the present invention offer the following advantageous arrangements: there is provided an imaging apparatus including an internal memory 4 for storing picture files 6d; a recording medium 6 which holds a database 6a for retaining registration information and a accommodates picture files 6b and which is attached removably to the imaging apparatus; and a control section 1 for creating the registration information about the picture files 6b to be copied from the internal memory 4 to the recording medium 6 at a suitable time, before adding the created registration information to the database 6a thereby maintaining consistency between the picture files and the registration information. When these inventive arrangements are in place and when picture files are copied from the internal memory 4 to the removable recording medium 6, consistency is ensured between the picture files and their registration information.

Although the description above contains many specificities, these should not be construed as limiting the scope of the invention but as merely providing illustrations of some of the presently preferred embodiments of this invention. Thus it is to be understood that changes and variations may be made without departing from the spirit or scope of the claims that follow. For example, the time at which to copy picture files from the internal memory to the removable recording medium as well as to create registration information anew is not limited to the above-described point in time. Alternatively, the copying of picture files and the creation of new registration information may take place when the imaging apparatus is plugged into an AC outlet.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
first storage means for storing picture files;
second storage means for storing a database for storing registration information and picture files, the second storage means being removably attached to the imaging apparatus; and
control means for creating the registration information about the picture files to be copied from the first storage means to the second storage means at a suitable time, the control means further adding the created registration information to the database so as to maintain consistency between the picture files and the registration information.

2. The imaging apparatus according to claim 1, wherein the control means for numbering file paths for the picture files to be copied and acquires supplementary information about the picture files before adding the file paths and the supplementary information to the database as part of the registration information.

3. The imaging apparatus according to claim 2, wherein the suitable time corresponds to the point in time at which the second storage means is detected to be attached to the imaging apparatus after reproduction of picture files has been started.

4. The imaging apparatus according to claim 2, wherein the suitable time corresponds to the point in time at which reproduction of picture files is started after the second storage means has been detected to be attached to the imaging apparatus.

5. A picture managing method comprising the steps of:
creating registration information about picture files to be copied from first storage means to second storage means at a suitable time; and
adding the registration information to a database constituting part of the second storage means so as to maintain consistency between the picture files and the registration information.

6. A program for causing a computer to perform a control procedure comprising the steps of:
creating registration information about picture files to be copied from first storage means to second storage means at a suitable time; and
adding the registration information to a database constituting part of the second storage means so as to maintain consistency between the picture files and the registration information.

7. An imaging apparatus comprising:
a first storage section configured to store picture files;
a second storage section configured to store a database for storing registration information and picture files, the second storage section being removably attached to the imaging apparatus; and
a control section configured to create the registration information about the picture files to be copied from the first storage section to the second storage section at a suitable time, the control section further adding the created registration information to the database so as to maintain consistency between the picture files and the registration information.
